(19) United States
(12) Patent Application Publication
(10) Pub. No.: US 2006/0165846 A1
(43) Pub. Date: Jul. 27, 2006

(54) Nutritional supplement containing honey

(75) Inventor: Vladimir Vlad, West Des Moines, IA (US)

Correspondence Address: MCKEE, VOORHEES & SEASE, P.L.C., 801 GRAND AVENUE, SUITE 3200, DES MOINES, IA, 50309-2721, US

(73) Assignee: Glycon Technologies, L.L.C., Ames, IA (US)

(21) Appl. No.: 11/333,116

(22) Filed: Jan. 17, 2006

Related U.S. Application Data
(60) Provisional application No. 60/646,262, filed on Jan. 24, 2005.
(60) Provisional application No. 60/646,690, filed on Jan. 24, 2005.

(51) Int. Cl. A23L 1/30

(52) U.S. Cl. 426/74

(57) ABSTRACT

An all natural solid form nutritional supplement comprising a mixture of a natural composition and honey, the mixture dried to a crystalline form to thereby provide the solid form nutritional supplement. The natural composition may be in liquid form, such as cider vinegar or in powdered form, such as egg shell powered. The resulting crystals can be packaged as a nutritional supplement or incorporated into food products. A method of producing the nutritional supplement is also provided, as well as a method for providing nourishment through administering a safe and effective amount of the nutritional supplement to a human or animal.

### RELATED APPLICATION

This application claims priority to U.S. Provisional Patent Application Ser. No. 60/646,262, filed Jan. 24, 2005, hereby incorporated by reference in its entirety. This application also claims priority to U.S. Provisional Patent Application Ser. No. 60/646,690, filed Jan. 24, 2005, hereby incorporated by reference in its entirety.

### BACKGROUND OF THE INVENTION

The present invention relates, generally to natural nutritional supplements using honey.

Apple cider vinegar and honey are recognized as a homeopathic remedy to certain ailments. The combination of apple cider vinegar and honey has been used for relaxing the nervous system, promoting deep sleep, relieving rheumatism, relieving arthritis, relieving bone pains, relieving heart ailments, relieving stress, treating insomnia, detoxifying, and reacting with uric acid in bones to give relief. Traditionally, this remedy has been administered through combining honey with apple cider vinegar with water in a form sometimes known has honeygar.

Honeygar is typically a mixture formed from equal amounts of raw unfiltered honey and apple cider vinegar (about one tablespoon each) into an 8 ounce glass of water that is just warm enough to melt the honey. The mixture is prepared by stirring until clear.

A seemingly unrelated problem, without having the benefit of this disclosure is the deficiencies of calcium in the human diet. Calcium is an important mineral which many individuals do not consume adequate amounts. Calcium supplements come in several forms (calcium salts), but only part of the calcium salt is elemental calcium. It is important to know how much elemental calcium a supplement provides because all the dietary recommendations refer to elemental calcium. To calculate how much elemental calcium is in a supplement, multiply the total milligrams (mg) by the fraction of elemental calcium to get total mg of elemental calcium. Egg shells contain approximately 36 to 37% elemental calcium in addition to traces of phosphorus and other trace elements. Thus, a 500 mg mass of dried powdered eggshell produces approximately 180 mg elemental calcium.

Despite any recognized benefits of apple cider vinegar and honey and despite the human body's known requirements for calcium, problems remain. Therefore, it is a primary object, feature or advantage of the present invention to improve upon the state of the art and provide nutritional supplements in a convenient manner to thereby promote increased use of the nutritional supplements.

Yet another object, feature, or advantage of the present invention is to provide a nutritional supplement product with improved handling.

Yet another object, feature, or advantage of the present invention is to provide a nutritional supplement that is palatable.

A further object, feature, or advantage of the present invention is to provide a nutritional supplement that can be combined with food products.

A further object, feature, or advantage of the present invention is to provide a nutritional supplement that is readily commercializable.

A still further object, feature, or advantage of the present invention is to provide a nutritional supplement in a dose form.

A still further object, feature, or advantage of the present invention is to provide a nutritional supplement in a solid form.

Yet another object, feature, or advantage of the present invention is to provide a nutritional supplement using honey which is in a form suitable for packaging, storage, and distribution.

One or more of these and/or other objects, features, or advantages of the present invention will become apparent from the specification and claims that follow.

### SUMMARY OF THE INVENTION

According to one aspect of the present invention, an all natural solid form nutritional supplement is provided. The nutritional supplement includes a mixture of a natural composition and honey, the mixture dried to a crystalline form to thereby provide the solid form nutritional supplement. The natural composition may be in liquid form, such as cider vinegar. Alternatively, the natural composition may be in powdered form, such as egg shell powder.

According to another aspect of the invention, a method of providing a natural solid form nutritional supplement is provided. The method includes admixing substantially equal amounts of honey and a natural composition to produce a mixture and then drying the mixture until crystallization. The method may further include separating the mixture after crystallization into dose form. The natural composition may be in liquid form, such as cider vinegar. Alternatively, the natural composition may be in powered form, such as egg shell powder.

According to another aspect of the invention, a method for providing nourishment includes administering a safe and effective amount of a nutritional supplement to a human or animal, to provide a nourishing amount of each ingredient of the nutritional supplement. The nutritional supplement includes a first ingredient obtainable from honey and a second ingredient which is an all natural ingredient. The first ingredient is admixed with the second ingredient and dried to a crystalline form. The second ingredient may be in liquid form, such as cider vinegar, or may be in a powdered form, such as powderized egg shells. The nutritional supplement may be administered in dose form. The nutritional supplement may be incorporated directly into a food product.

### BRIEF DESCRIPTION OF THE DRAWINGS

FIG. 1 is a diagram illustrating an overview of one embodiment of the present invention.

### DETAILED DESCRIPTION OF THE PREFERRED EMBODIMENT

The present invention provides for combining nutrients with honey and then drying the combination to a crystallized form. In one example, honey is combined with cider vinegar and dried into a crystallized form. In another example, eggshell powder is combined with honey and the combination is dried into a crystallized form. The use of honey in the nutritional supplement is highly advantageous in a number of respects. First, honey is very palatable, thus less palatable ingredients can be combined with honey and still produce a palatable end product. Second, due to the fact that honey crystallizes when dried, a solid form is ultimately produced. The solid form can be separated and packaged for use in dose form. Alternatively, the solid form can be incorporated into food products, either at the time of manufacturing of the food products or as an all natural additive as a part of food preparation. This crystallization property of honey is particularly useful when the honey is being combined with an ingredient which is in a less palatable form or more inconvenient form. For example, the honey can be combined with an ingredient in liquid form, such as cider vinegar. By way of another example, the honey can be combined with an ingredient in powdered form, such as powderized egg shells which contain elemental calcium. In both cases the ingredient alone is not particularly palatable and its original form is inconvenient to administer.

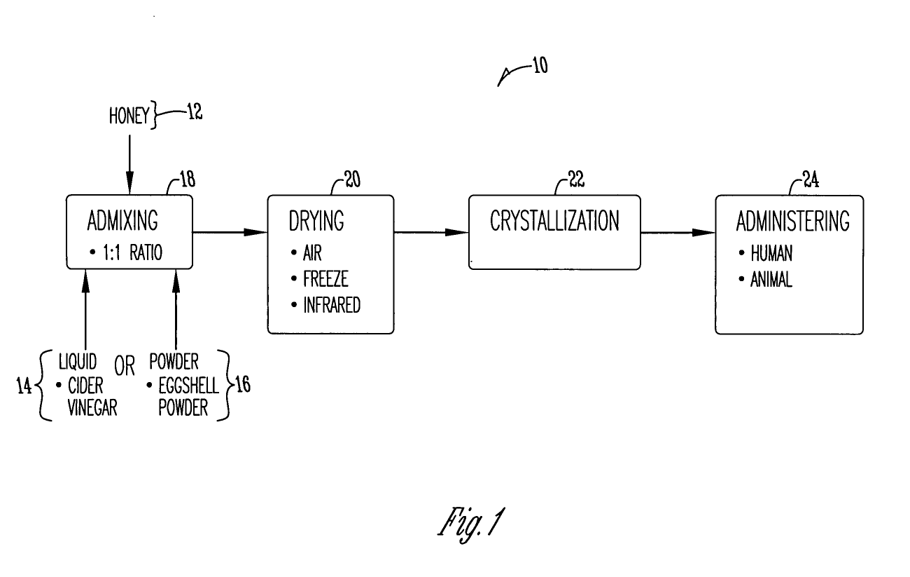

FIG. 1 illustrates one embodiment of a method 10 of the present invention. The present invention is not to be limited to the specific embodiment shown in FIG. 1. In FIG. 1, honey 12 and a liquid 14 such as cider vinegar or else a powder 16 such as eggshell powder is admixed in step 18. One preferred ratio for the honey ingredient relative to another, preferably all natural ingredient, is a 1 to 1 ratio. Next, in step 20, drying is performed. The drying can be air drying, freeze drying, infrared drying, or other types of drying suitable for reducing the moisture content of the mixture sufficiently to provide for crystallization. In step 22, crystallization occurs. Step 24 provides for administering the resulting product, such as to a human or animal.

Two specific examples of the present invention are provided below. The present invention is not to be limited to these specific examples. What is described is merely exemplary.

### Cider Vinegar

The present invention provides for a combining cider vinegar with honey and then drying the combination to a crystallized form. In one embodiment of the present invention, equal amounts of honey and cider vinegar are combined. Although equal amounts are preferred, the present invention contemplates that different amounts of each ingredient may be mixed. The resulting mixture is then dried, such as through use of a food dehydrator until the resulting mixture is reduced to a crystalline form. The present invention contemplates that the mixture can be dried through air drying, freeze drying, or other types of drying. The crystalline form can be packaged as a nutritional supplement or incorporated into food products. The crystalline form can be conveniently sprinkled upon existing food products or otherwise combined with existing products.

The crystalline form of the honey and cider vinegar provides numerous advantages. One advantage is that the crystalline form of the mixture has the same potency as a much larger liquid dose of honey and cider vinegar. The crystalline form of the mixture can be readily consumed with or incorporated into existing food products. The crystalline product is also easier to handle than liquid products and is more conducive to storage and handling.

### Egg Shell Powder

The present invention provides for a combining eggshell powder with honey and then drying the combination to a crystallized form. In one embodiment of the present invention, equal amounts of honey and eggshell powder are combined. Although equal amounts are preferred, the present invention contemplates that different amounts of each ingredient may be mixed. The resulting mixture is then dried, such as through use of a food dehydrator until the resulting mixture is reduced to a crystalline form. The present invention contemplates that the mixture can be dried through air drying, infrared drying, freeze drying, or other types of drying. The crystalline form can be packaged as a nutritional supplement or incorporated into food products. The crystalline form can be conveniently sprinkled upon existing food products or otherwise combined with existing products.

The crystalline form of the honey and eggshell powder provides numerous advantages. The crystalline form of the mixture can be readily consumed with or incorporated into existing food products. The crystalline product can also be easily stored and handled.

Therefore, a nutritional supplement using honey has been disclosed. The present invention contemplates numerous variations, including variations in precise proportions of honey to other ingredients, variations in the number and type of ingredients, and other variations all within the spirit and scope of the invention.

What is claimed is:

1. An all natural solid form nutritional supplement comprising a mixture of a natural composition and honey, the mixture dried to a crystalline form to thereby provide the solid form nutritional supplement.

2. The nutritional supplement of claim 1 wherein the natural composition is a liquid.

3. The nutritional supplement of claim 2 wherein the liquid is cider vinegar.

4. The nutritional supplement of claim 1 wherein the natural composition is a powder.

5. The nutritional supplement of claim 4 wherein the powder is egg shell powder comprising elemental calcium.

6. The nutritional supplement of claim 1 wherein the mixture being one part of the natural composition to one part of the honey.

7. A method of providing a natural solid form nutritional supplement, comprising:
admixing substantially equal amounts of honey and a natural composition to produce a mixture; and
drying the mixture until crystallization.

8. The method of claim 7 further comprising separating the mixture after crystallization into dose form.

9. The method of claim 7 wherein the natural composition is in liquid form.

10. The method of claim 9 wherein the natural composition is cider vinegar.

11. The method of claim 7 wherein the natural composition is in powdered form.

12. The method of claim 11 wherein the natural composition is egg shell powder.

13. A method for providing nourishment comprising administering a safe and effective amount of a nutritional supplement to a human or animal, to provide a nourishing amount of each ingredient of the nutritional supplement, said nutritional supplement comprising a first ingredient obtainable from honey and a second ingredient being an all natural ingredient, wherein the first ingredient is admixed with the second ingredient and dried to a crystalline form.

14. The method of claim 13 wherein the second ingredient being in liquid form.

15. The method of claim 14 wherein the second ingredient consists of cider vinegar.

16. The method of claim 13 wherein the second ingredient being in powdered form.

17. The method of claim 16 wherein the second ingredient consists of powderized egg shells.

18. The method of claim 13 wherein the step of administering is administering in dose form.

19. The method of claim 13 wherein the step of administering is administering through incorporation into a food product.
